(19) United States
(12) Patent Application Publication
(10) Pub. No.: US 2016/0316011 A1
(43) Pub. Date: Oct. 27, 2016

(54) SDN NETWORK ELEMENT AFFINITY BASED DATA PARTITION AND FLEXIBLE MIGRATION SCHEMES

(71) Applicant: Telefonaktiebolaget L M Ericsson (publ), Stockholm (SE)

(72) Inventors: Chandramouli Venkataraman, Bangalore (IN); Muthukumaran Kothandaraman, Bangalore (IN)

(21) Appl. No.: 14/697,513

(22) Filed: Apr. 27, 2015

(51) Int. Cl. H04L 29/08; H04L 12/24

(52) U.S. Cl. CPC H04L 67/1095; H04L 67/104; H04L 41/20

(57) ABSTRACT

A method is performed by a controller node to support network element (NE) data migration. The controller node is part of a cluster of controller nodes in a software defined networking (SDN) network. The method includes detecting that a peer controller node in a same replication zone as the controller node has failed, where the peer controller node is a master for data associated with an NE and the controller node is a backup for the data associated with the NE, transitioning a state of the NE to a migration state, transferring the data associated with the NE from backup storage (Zb) of the controller node to dead storage (Zd) of the controller node, receiving a request for the data associated with the NE from a requesting controller node, and transferring at least a fragment of the data associated with the NE to the requesting controller node.

### FIELD

Embodiments of the invention relate to the field of software defined networking (SDN). More specifically, the embodiments of the invention relate to a data partition and data migration scheme in an SDN network.

### BACKGROUND

Software Defined Networking (SDN) is an approach to computer networking that employs a split architecture network in which the forwarding (data) plane is decoupled from the control plane. The use of a split architecture network simplifies the network elements (NEs) (e.g., switches) implementing the forwarding plane by shifting the intelligence of the network into one or more controllers that oversee the switches.

In a typical SDN network, a controller is implemented as a cluster of controller nodes that control a set of NEs, where each NE is controlled by a single controller node in the cluster. A wide range of network applications use the controller framework to program the NEs. In order to simplify application logic, the controller provides a standard SQL/no-SQL data-store interface for applications to store their data and to perform create, read, update, and delete (CRUD) operations. These data stores inherently provide data replication and data distribution across the cluster nodes thereby offering scalability and fault tolerance in a clustered environment. Applications are agnostic to the location of their data in the data store. To this extent, the controller looks like any other enterprise server application.

Each NE in a SDN network is generally connected to a single controller node in the cluster. The controller node connected to the NE will program and control the NE. The pairing of an NE to a controller, called NE-controller affinity, can affect the latency involved with data access. Typically, it is desirable for data associated with an NE to be stored in the controller that controls the NE.

NEs can migrate to a different controller node in the cluster due to various conditions. In such a case, a new controller node will control the NE but this may not result in the data associated with the NE moving to the new controller node as the data store is agnostic to NE migration. Hence, this can introduce latencies in data access, particularly in the context of reactive applications, due to unnecessary east-west communication overheads to retrieve data associated with the NE. The east-west communication overhead to access data can become a potential bottleneck for network performance.

### SUMMARY

A method is performed by a controller node to support network element (NE) data migration. The controller node is part of a cluster of controller nodes in a software defined networking (SDN) network. The method includes detecting that a peer controller node in a same replication zone as the controller node has failed, where the peer controller node is a master for data associated with an NE and the controller node is a backup for the data associated with the NE, transitioning a state of the NE to a migration state, transferring the data associated with the NE from backup storage (Zb) of the controller node to dead storage (Zd) of the controller node, receiving a request for the data associated with the NE from a requesting controller node, and transferring at least a fragment of the data associated with the NE to the requesting controller node.

A network device is configured to support network element (NE) data migration. The network device implements a controller node in a cluster of controller nodes in a software defined networking (SDN) network. The network device includes a non-transitory machine readable storage medium to store an NE data migration component. The network device also includes a processor that is communicatively coupled to the non-transitory machine readable storage medium. The processor is configured to execute the NE data migration component. The NE data migration component is configured to detect that a peer controller node in a same replication zone as the controller node has failed, where the peer controller node is a master for data associated with an NE and the controller node is a backup for the data associated with the NE, transition a state of the NE to a migration state, cause the data associated with the NE to be transferred from backup storage (Zb) of the controller node to dead storage (Zd) of the controller node, and in response to a request for the data associated with the NE from a requesting controller node, cause at least a fragment of the data associated with the NE to be transferred to the requesting controller node.

A non-transitory computer readable medium has stored therein instructions to be executed by a network device for supporting network element (NE) data migration. The network device acts as a controller node in a cluster of controller nodes in a software defined networking (SDN) network. The instructions, when executed by the network device, cause the network device to perform a set of operations including, detecting that a peer controller node in a same replication zone as the controller node has failed, where the peer controller node is a master for data associated with an NE and the controller node is a backup for the data associated with the NE, transitioning a state of the NE to a migration state, transferring the data associated with the NE from backup storage (Zb) of the controller node to dead storage (Zd) of the controller node, receiving a request for the data associated with the NE from a requesting controller node, and transferring at least a fragment of the data associated with the NE to the requesting controller node.

A computing device implements a plurality of virtual machines for implementing network function virtualization (NFV), where a virtual machine from the plurality of virtual machines is configured to implement a controller node in a cluster of controller nodes in a software defined networking (SDN) network that supports network element (NE) data migration. The computing device includes a storage medium to store a controller-specific output action component and a processor communicatively coupled to the storage medium. The processor is configured to execute the virtual machine, where the virtual machine is configured to implement the controller-specific output action component. The controller-specific output action component is configured to detect that a peer controller node in a same replication zone as the controller node has failed, where the peer controller node is a master for data associated with an NE and the controller node is a backup for the data associated with the NE, transition a state of the NE to a migration state, cause the data associated with the NE to be transferred from backup storage (Zb) of the controller node to dead storage (Zd) of the controller node, and in response to a request for the data associated with the NE from a requesting controller node, cause at least a fragment of the data associated with the NE to be transferred to the requesting controller node.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a data partition scheme in a SDN network that takes NE-controller affinity into consideration.

FIG. 2A is a diagram illustrating one embodiment of data migration in a SDN network that takes NE-controller affinity into consideration, when controller node C1 fails and network element NE1 reconnects to controller node C3 in replication zone Z2.

FIG. 2B is a diagram illustrating one embodiment of data migration in a SDN network that takes NE-controller affinity into consideration, when controller node C3 fails during data migration and network element NE1 reconnects to controller node C4 in replication zone Z2.

FIG. 2C is a diagram illustrating one embodiment of a data partition after data migration has finished and the NEs are in stable state.

FIG. 3 is a flow diagram illustrating one embodiment of a process for supporting NE data migration that takes NE-controller affinity into consideration, from the perspective of a controller node that detects failure of a peer controller node.

FIG. 4 is a flow diagram illustrating one embodiment of a process for supporting NE data migration that takes NE-controller affinity into consideration, from the perspective of a controller node to which an NE connects.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 6 illustrates a general purpose control plane device with centralized control plane (CCP) software, according to some embodiments of the invention.

### DESCRIPTION OF EMBODIMENTS

The following description describes methods and apparatus for network element (NE) data migration that takes NE-controller affinity into consideration. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Software Defined Networking (SDN) is a network architecture in which the control plane is decoupled from the forwarding plane. A SDN network typically includes multiple forwarding elements (e.g., network elements (NE) or switches) interconnecting each other and one or more controllers that control the forwarding behavior of the NEs. Typically, a controller in a SDN network is a cluster of controller nodes that manage a set of NEs, where each NE is controlled by a single controller node in the cluster. A wide range of network applications use the controller framework to program the NEs. In order to simplify application logic, the controller may provide a standard Structured Query Language (SQL) or no-SQL data store interface for applications to store their data and to perform create, read, update, and delete (CRUD) operations. These data stores can provide data replication and data distribution across the cluster nodes thereby offering scalability and fault tolerance in a clustered environment. Applications are agnostic to the location of their data in the data store. To this extent, the controller looks like any other enterprise server application.

Each NE in a SDN network is generally connected to a single controller node in the cluster. The controller node connected to the NE will control and program the NEs proactively or reactively, depending on network design. The pairing of an NE to a controller node, referred to herein as NE-controller affinity, can affect the latency involved with data access. In general, data access time can be minimized by storing data associated with an NE (i.e., the NE's data) on a controller node that controls the NE. NEs can migrate to a different controller node in the cluster due to various conditions. In such a case, a new controller node will control the NE but this may not result in the NE's data moving to the new controller node as the data store is agnostic to NE migration. Hence, this can introduce latencies in data access, particularly in the context of reactive applications, due to unnecessary east-west communication overheads to retrieve NE data. The east-west communication overhead to access data can become a potential bottleneck for network performance.

SDN controllers that utilize standard databases do not have the flexibility to dictate how data is partitioned and thus are not able to store and move an NE's data closer to the NE. NE data in SDN networks are mutated at a high frequency (for example, due to flow aging, reacting to a Packet-In message, statistics gathering, etc.). This can potentially introduce latencies in data access, particularly in the context of reactive applications that frequently react to network state changes and other network events. Current data store solutions in controllers do not take NE-controller affinity information into consideration, which can result in increased latency and poor scaling.

Generally, in a scaled cluster configuration, data replication is based on zones that contain a subset of cluster nodes. In such a configuration, NE data information is usually only available to the nodes that are part of the same zone. This can impose restrictions for an NE that reconnects to a node outside the zone as the NE data is not available outside the zone.

Embodiments of the invention provide benefits over the prior art by providing a data partition scheme and a data migration process that takes NE-controller affinity into consideration. Embodiments help maintain an NE's data on the controller node that controls the NE, thereby reducing data access latencies. When an NE moves to a different controller node, the NE's data moves along with the NE. Also, embodiments of the data migration process enable seamless reconnection of an NE to any controller node within a cluster. Further, embodiments of the data migration process provide fault tolerance so that even if the new controller node to which an NE connects fails, the NE can move to another controller node and ensure data migration is not affected. The embodiments thus reduce the east-west communication overhead, reduce latency, and improve scaling. Various embodiments will be described herein below in additional detail.

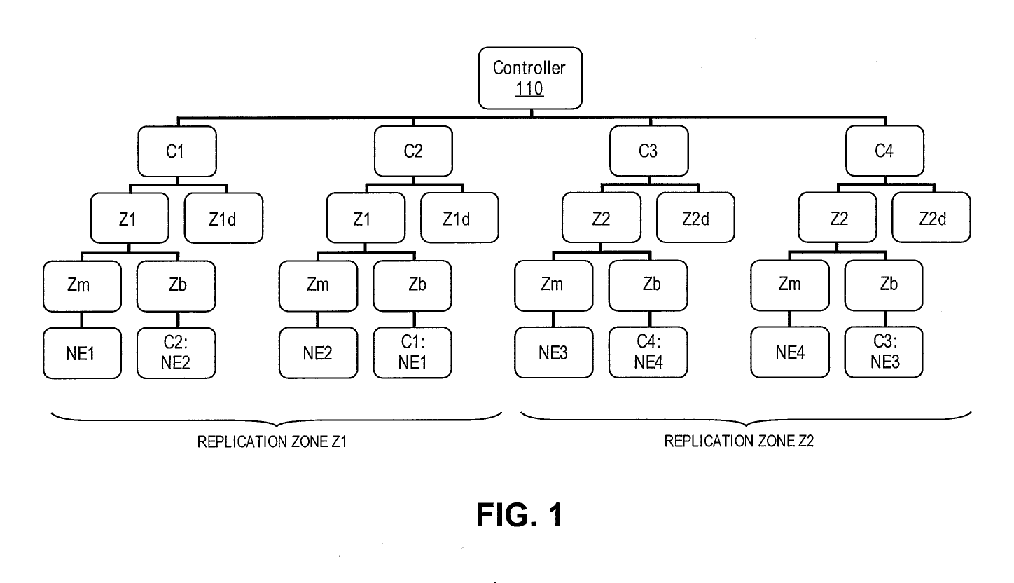

FIG. 1 is a diagram of one embodiment of a data partition scheme in a SDN network that takes NE-controller affinity into consideration. The SDN network includes a controller 110 with four controller nodes (i.e., C1, C2, C3, and C4). The controller nodes are grouped into two replication zones (i.e., Z1 and Z2). Controller nodes C1 and C2 are members of replication zone Z1. Controller nodes C3 and C4 are members of replication zone Z2. Controller nodes within the same replication zone form replication peers with each other. In this example, C1 and C2 are replication peers because they are both members of replication zone Z1. Similarly, C3 and C4 are replication peers because they are both members of replication zone Z2. In one embodiment, a controller node is mapped to a single replication zone as part of the cluster configuration. In other embodiments, a controller node can be mapped to more than one replication zone. Data can be replicated within a replication zone using any suitable replication algorithm. For example, data can be replicated within a replication zone using the Raft or Paxos consensus algorithms.

Each controller node hosts a group of one or more NEs (e.g., switches) and is considered the master for the data relating to these NEs. Other controller nodes within the replication zone are considered as a backup for the data relating to these NEs. The SDN network of FIG. 1 includes four NEs (i.e., NE1, NE2, NE3, and NE4). C1 controls NE1 and is a master for NE1 data. C2 controls NE2 and is a master for NE2 data. C3 controls NE3 and is a master for NE3 data. C4 controls NE4 and is a master for NE4 data. C1 is a backup for NE2 data since NE2 is controlled by a controller in the same replication zone as C1 (i.e., C2 in replication zone Z1). C2 is a backup for NE1 data since NE1 is controlled by a controller in the same replication zone as C2 (i.e., C1 in replication zone Z1). C3 is a backup for NE4 data since NE4 is controlled by a controller in the same replication zone as C3 (i.e., C4 in replication zone Z2). C4 is a backup for NE3 data since NE3 is controlled by a controller in the same replication zone as C4 (i.e., C3 in replication zone Z2). A controller node that hosts an NE and is a master for that NE's data will be referred to herein as a master controller node for that NE. A controller node that is a backup for an NE's data will be referred to herein as a backup controller node for that NE.

Since a controller node acts as master for data of NEs the controller node hosts and acts as a backup for data of NEs controlled by the controller node's peer controller nodes within a replication zone, the controller node can divide data within the replication zone into two components. The first component is a master zone component or master storage (Zm), which stores data of the NEs controlled by the controller node. The second component is a backup zone component or backup storage (Zb), which stores data of the NEs controlled by the replication peers of the controller node. In this example, C1 stores NE1 data in its Zm and stores NE2 data in its Zb. C2 stores NE2 data in its Zm and stores NE1 data in its Zb. C3 stores NE3 data in its Zm and stores NE4 data in its Zb. C4 stores NE4 data in its Zm and stores NE3 data in its Zb.

Additionally, each controller includes a dead zone component or dead storage (Zd), which stores data of an NE whose master controller node is down and the NE is in migration state to another master controller node. When a controller node that hosts an NE goes down, the NE typically attempts to reconnect to a new master controller node. The NE is said to be in a migration state until the NE's data is migrated to the new master controller node. In one embodiment, if data for an NE is stored in the Zd of a controller node that is a master controller node for the NE, then the Zd is replicated to the controller node's replication peers. As will be apparent from the descriptions below, this allows for proper handling of scenarios where multiple controller nodes fail in succession. In one embodiment, if data for an NE is stored in the Zd of a controller node but the controller node is not the master controller node for the NE, then the Zd is not replicated to the controller node's replication peers.

More generally, if C1 to Cn are the controller nodes in a cluster and Z1 to Zm are the replication zones configured in the cluster, then in one embodiment, the following mapping is maintained in each controller node:

Replication Zones={Z1, Z2, . . . , Zm}

Z1={Zm, Zb} where 0<i<m

Zm={NE1, NE2, . . . , NEa} where NE1 to NEa are the set of NEs that are controlled by the controller node

Zb={ZC1, ZC2, . . . , ZCb} where ZC1 to ZCb are the set of replication peers that are backed up by the controller node

ZC1={NEₓ, NEₓ₊₁, NEₓ₊₂, . . . NEₓ₊ₙ} where NEx to NEₓ₊ₙ are the set of NEs that are controlled by a replication peer ZC1

Zd={ZC1, ZC2, . . . , ZCc} where ZC1 to ZCc are the controller nodes that are down whose NEs are in migration state

As part of data migration, each controller node maintains the state of an NE. An NE can be in a stable state or a migration state. An NE is in a stable state when the NE is controlled by a master controller node and none of the NE's data exists in any other replication zone (i.e., the NE is not in migration). When an NE is in a stable state, the data of the NE will be stored in Zm of the master controller node and in Zb of the backup controller nodes in the replication zone. An NE is in a migration state when the NE initially connects to a controller node or reconnects to a controller node (i.e., connects to a new master controller node) due to a connectivity failure with the NE's previous master controller node. When an NE is in a migration state, the data of the NE will be in Zd of the new master controller node and in Zd of the NE's previous master controller node's replication zone, and is in the process of getting synced with the new master controller node.

When a controller node fails, the controller node's replication peers in the same replication zone detect the failure and transition the state of NEs hosted by the failed controller node to a migration state. Each replication peer then moves data of NEs of the failed controller node from their respective Zb to Zd. The NEs of the failed controller node meanwhile reconnect to a new master controller node. Each new master controller node then sets the state of the reconnecting NE to a migration state. The new master controller node then queries a randomly selected controller node in each replication zone to determine whether the NE's data still exists in that selected controller node's Zd. If so, the new master controller node transmits a request to retrieve the NE's data from the selected controller node. In one embodiment, when data migration from the selected controller node to the new master controller node is finished, the selected controller node transmits a done message to the new master controller node, and the new master controller node responds to the done message with an acknowledgment message. When the selected controller node receives the acknowledgment message, the selected controller node deletes the NE's data from the selected controller node's Zd. This process is repeated by the new master controller node in each of the old replication zones on which an NE was present. If the process is repeated more than once, this means that multiple controller nodes failed in quick succession, which is a rare condition in practice.

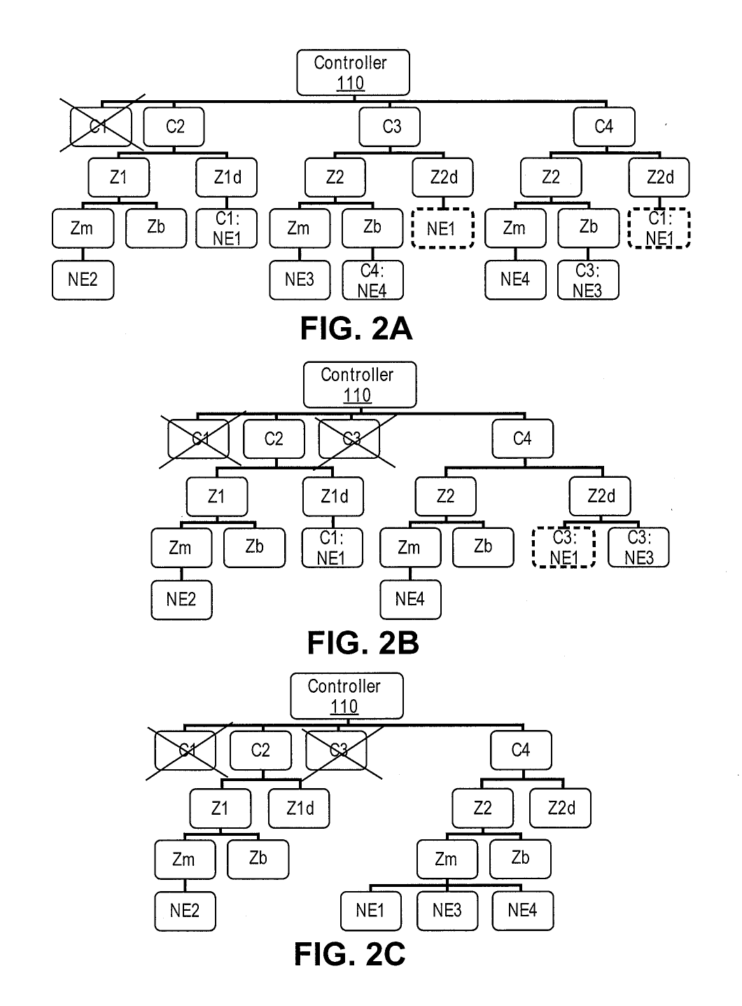

When data migration from the other replication zones has finished, then the NE's data is moved from Zd of the new master controller node to Zm of the new master controller node, and the state of the NE is set to a stable state. During the entire data migration process, the new master controller node allows updates to the NE's data, thereby not blocking updates to the NE's data during data migration. In one embodiment, only the master controller node will be responsible for updating the NE's data. In such an embodiment, the rest of the controller nodes, at most, have stale NE data in their Zd. An example scenario that applies this data migration process will be described below with reference to FIGS. 2A-C. It should be understood that the scenario described below is provided by way of example and not limitation, and that the data migration process can be applied to different scenarios than the ones described below. For example, the data migration process can be applied to a SDN network having a different topology and different sequence of controller node failures than illustrated in FIGS. 2A-C.

FIG. 2A is a diagram illustrating one embodiment of data migration in a SDN network that takes NE-controller affinity into consideration, when controller node C1 fails and network element NE1 reconnects to controller node C3 in replication zone Z2. When C1 fails, C2 detects that C1 failed and transitions the state of NE1 to a migration state and moves NE1's data from C2's Zb to Z1d. Meanwhile, NE1 reconnects to C3, which sets the state of NE1 to a migration state and maintains NE1's data in its Z2d. C3 then initiates migration of NE1's data from other replication zones. In this example, C3 retrieves NE1's data from C2's Z1d. Also, NE1's data is replicated to C4's Z2d since C4 is in the same replication zone as C3.

FIG. 2B is a diagram illustrating one embodiment of data migration in a SDN network that takes NE-controller affinity into consideration, when controller node C3 fails during data migration and network element NE1 reconnects to controller node C4 in replication zone Z2. Continuing with the example scenario described above with respect to FIG. 2A, during migration of NE1's data from C2 to C3, C3 also fails. C4, which is in the same replication zone as C3, detects this failure of C3 and moves NE3's data from its Zb to Z2d. Meanwhile, NE1 reconnects to C4. When NE1 connects to C4, C4 transitions the state of NE1 to a migration state (if NE1 is not already in migration state). As mentioned above, since C4 is a replication peer of C3, some of NE1's data may already be present in C4's Z2d. C4 then initiates migration of NE1's data from other replication zones. In this example, C4 retrieves NE1's data from C2's Z1d.

FIG. 2C is a diagram illustrating one embodiment of a data partition after data migration has finished and the NEs are in a stable state. Continuing with the example described above with respect to FIG. 2B, when migration of NE1's data from C2 to C4 is finished, NE1's data is deleted from C2's Z1d and NE1's data is moved from C4's Z2d to C4's Zm. C4 then sets the state of NE1 to a stable state. This completes data migration for NE1 data. During the data migration process, the new master controller nodes for NE1 (namely C3 and C4) do not have to restrict updates to NE1's data. As a result of the data migration process, NE1's data is stored on NE1's new master controller node (i.e., C4). Further, NE1's data has been successfully migrated to NE1's new master controller node (i.e., C4) despite the failures of C1 and C3. For simplicity and clarity, the data migration process has been described primarily with respect to NE1's data. However, it should be understood that data for other NEs can be migrated in a similar fashion.

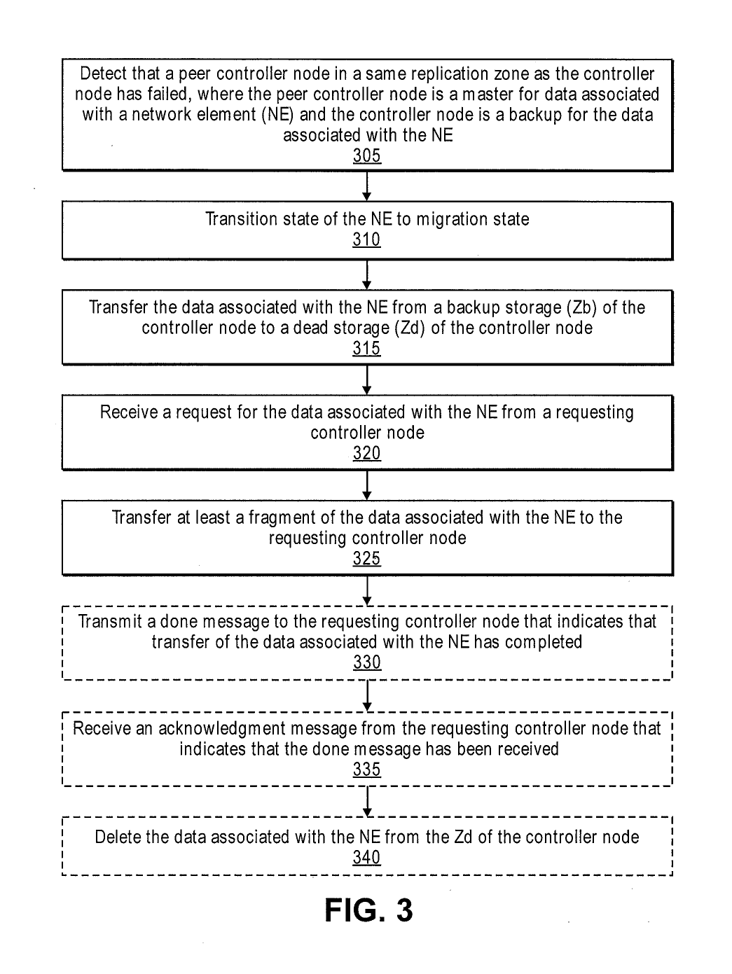

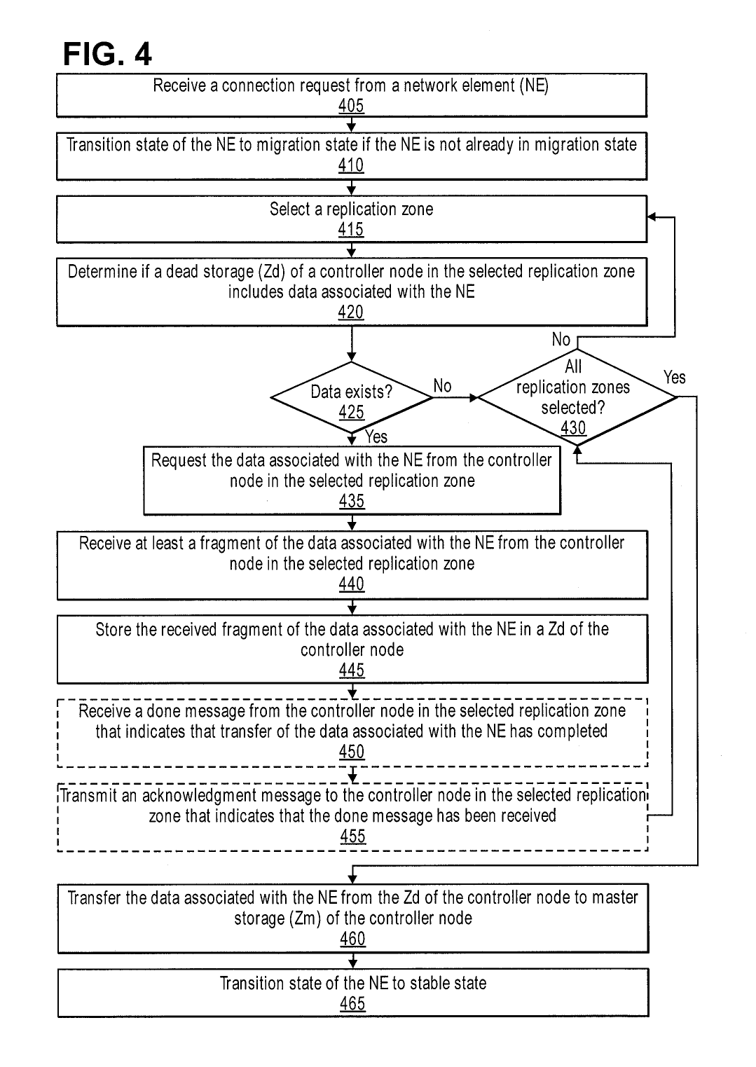

The operations in the flow diagrams of FIG. 3 and FIG. 4 will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

FIG. 3 is a flow diagram illustrating one embodiment of a process for supporting NE data migration that takes NE-controller affinity into consideration, from the perspective of a controller node that detects failure of a peer controller node. In one embodiment, the operations of the flow diagram may be performed by a controller node in a cluster of controller nodes in a SDN network.

In one embodiment, the process is initiated when the controller node detects that a peer controller node in a same replication zone as the controller node has failed (block 305). The peer controller node controls an NE and is a master for data associated with the NE. Also, since the controller node is in the same replication zone as the peer controller node, the controller node is a backup for data associated with the NE. As such, the controller node stores a replica or backup of the data associated with the NE in its backup storage (Zb).

Upon detecting that the peer controller node has failed, the controller node transitions a state of the NE to a migration state (block 310). The controller node then transfers the data associated with the NE from a backup storage (Zb) of the controller node to a dead storage (Zd) of the controller node (block 315). In one embodiment, transfer of the data associated with the NE from the Zb of the controller node to the Zd of the controller node is a subtree reference move without the need for copying data over.

The controller node receives a request for the data associated with the NE from a requesting controller node (block 320). Typically, this request will come from the new controller node to which the NE connects. The controller node then transfers at least a fragment of the data associated with the NE to the requesting controller node (block 325). In one embodiment, the controller node transfers fragments of the data associated with the NE to the requesting controller node. The requesting controller node may transmit an acknowledgment message back to the controller node for each fragment that the requesting controller node successfully receives. In one embodiment, the controller node may delete fragments of the data associated with the NE from its Zd as the controller node receives corresponding acknowledgment messages from the requesting controller node. In one embodiment, as will be discussed further herein below, the controller node waits until all the data associated with the NE has migrated before deleting the data associated with the NE from the controller node's Zd.

In one embodiment, when all the data associated with the NE has been transferred, the controller node transmits a done message to the requesting controller node (block 330). The done message indicates to the requesting controller node that transfer of the data associated with the NE has completed. In one embodiment, the controller node then receives an acknowledgment message from the requesting controller node that indicates that the requesting controller node has received the done message (block 335). In one embodiment, the controller node deletes the data associated with the NE from the Zd of the controller node (block 340) upon receiving the acknowledgment message. In one embodiment, the controller node also deletes data associated with the NE from the Zd of the controller node's replication peers (i.e., controller nodes within the same replication zone) after receiving an acknowledgment message from the requesting controller node (i.e., either the message acknowledging receipt of an individual fragment or the message acknowledging receipt of the done message).

FIG. 4 is a flow diagram illustrating one embodiment of a process for supporting NE data migration that takes NE-controller affinity into consideration, from the perspective of a controller node to which an NE connects. In one embodiment, the operations of the flow diagram may be performed by a controller node in a cluster of controller nodes in a SDN network.

In one embodiment, the process is initiated when the controller node receives a connection request from an NE (block 405). The NE could be connecting to the controller node because the controller node that previously controlled the NE has failed.

The controller node transitions a state of the NE to a migration state if the NE is not already in a migration state (block 410). The state of the NE may already be in a migration state if the NE was previously controlled by a peer controller node of the controller node and the controller node detected a failure of the peer controller node (see block 310 in FIG. 3).

The controller node selects a replication zone (block 415). The controller node selects a replication zone to check whether data associated with the NE exists within that replication zone. In one embodiment, the controller node checks each replication zone for data associated with the NE. The controller node may iterate through the replication zones in any order. In one embodiment, the controller node randomly selects a replication zone that has not been selected before. In other embodiments, the controller node may select a replication zone in an orderly fashion by iterating through replication zones in alphabetical order, numerical order, or some other order based on an identifier associated with each replication zone.

The controller node then determines if dead storage (Zd) of a controller node in the selected replication zone includes data associated with the NE (block 420). At decision block 425, if data associated with the NE does not exist, then the controller node determines whether all replication zones have been selected (decision block 430). If not, then the controller node selects another replication zone (block 415). The controller node iterates through the replication zones in this fashion to find all of the data associated with the NE.

Returning to decision block 425, if data associated with the NE is included in the Zd of a controller node in the selected replication zone, then the controller node requests the data associated with the NE from the controller node in the selected replication zone (block 435). The controller node then receives at least a fragment of the data associated with the NE from the controller node in the selected replication zone (block 440). The controller node stores the received data associated with the NE in a Zd of the controller node (block 445). In one embodiment, the controller node replicates the data associated with the NE that is stored in the Zd of the controller node to one or more of the controller node's replication peers. In one embodiment, the controller node receives fragments of the data associated with the NE from the controller node in the selected replication zone. The controller node may then transmit an acknowledgment message to the controller node in the selected replication zone for each fragment that the controller node successfully receives.

In one embodiment, the controller node receives a done message from the controller node in the selected replication zone that indicates that transfer of the data associated with the NE has completed (block 450). In one embodiment, the controller node responds to the done message by transmitting an acknowledgment message to the controller node in the selected replication zone that indicates that the done message has been received (block 455).

The controller node then determines whether all replication zones have been selected (decision block 430). If not, then the controller node selects another replication zone not previously selected (i.e., a replication zone not previously selected for determining if a Zd of a controller node in the selected replication zone includes data associated with the NE). In this fashion, the process may iterate through each of the replication zones to perform the operations of blocks 420-455 therein to migrate data associated with the NE (if it exists) to the controller node (i.e., the new master controller node of the NE). If multiple controller nodes fail during NE migration, data associated with an NE can exist in multiple replication zones, with each replication zone storing a part of the data in Zd. Iterating through all replication zones to check for data associated with the NE ensures that all of the data associated with the NE is migrated to the new master controller node. In one embodiment, the controller node may modify the data associated with the NE while the NE is in a migration state. For example, this may occur if a user or an application makes a request to update data associated with the NE while the NE is in a migration state. In such a scenario, the controller node may iterate through the replication zones in a similar fashion as described above to consistently maintain and update the data associated with the NE across replication zones. This is to ensure that updates to the NE's data are not blocked, but at the same time does not make the NE data inconsistent.

Returning to decision block 430, if all replication zones have been selected, then this means that all data associated with the NE has been migrated. As such, the controller node transfers the data associated with the NE from the Zd of the controller node to a master storage (Zm) of the controller node (block 460). The controller node then transitions the state of the NE to a stable state (block 465). As a result of this process, data associated with the NE is migrated from previous replication zones in which the NE resided to the NE's new master controller node. Further, by utilizing a dead storage (i.e., Zd), the data migration process provides fault tolerance so that even if a new controller node to which an NE connects fails, the NE can move to another controller node and ensure data migration is not affected.

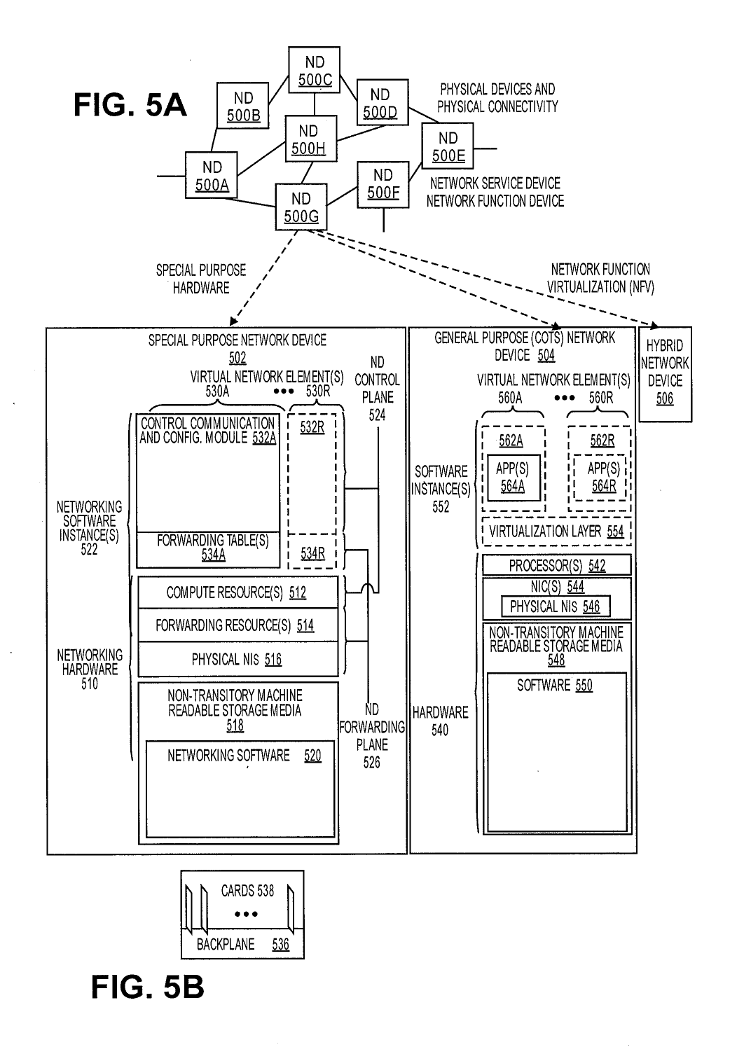

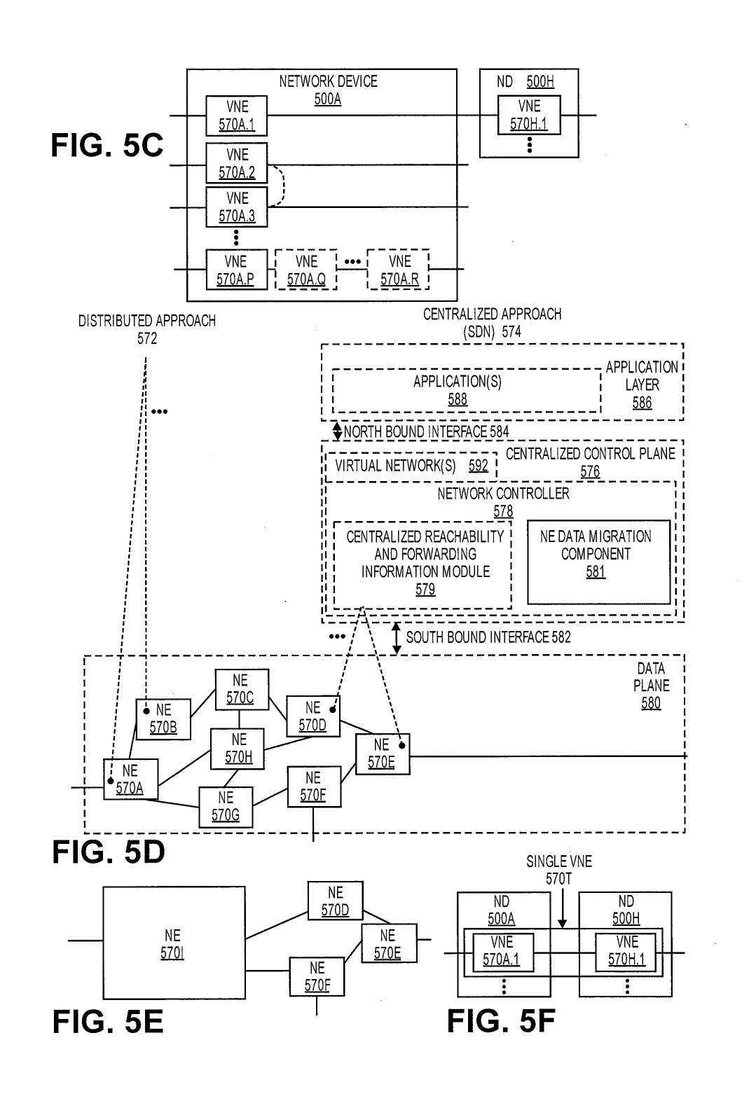

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated-circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. During operation, the processor(s) 542 execute the software 550 to instantiate one or more sets of one or more applications 564A-R. While one embodiment does not implement virtualization, alternative embodiments may use different forms of virtualization—represented by a virtualization layer 554 and software containers 562A-R. For example, one such alternative embodiment implements operating system-level virtualization, in which case the virtualization layer 554 represents the kernel of an operating system (or a shim executing on a base operating system) that allows for the creation of multiple software containers 562A-R that may each be used to execute one of the sets of applications 564A-R. In this embodiment, the multiple software containers 562A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 554 represents a hypervisor (sometimes referred to as a virtual machine monitor (VMM)) or a hypervisor executing on top of a host operating system; and 2) the software containers 562A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 564A-R, as well as the virtualization layer 554 and software containers 562A-R if implemented, are collectively referred to as software instance(s) 552. Each set of applications 564A-R, corresponding software container 562A-R if implemented, and that part of the hardware 540 that executes them (be it hardware dedicated to that execution and/or time slices of hardware temporally shared by software containers 562A-R), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 562A-R differently. For example, while embodiments of the invention are illustrated with each software container 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 562A-R to VNEs also apply to embodiments where such a finer level of granularity is used.

In certain embodiments, the virtualization layer 554 includes a virtual switch that provides similar forwarding services as a physical Ethernet switch. Specifically, this virtual switch forwards traffic between software containers 562A-R and the NIC(s) 544, as well as optionally between the software containers 562A-R; in addition, this virtual switch may enforce network isolation between the VNEs 560A-R that by policy are not permitted to communicate with each other (e.g., by honoring virtual local area networks (VLANs)).

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software containers 562A-R may operate as servers; the same would be true for the hybrid network device 506; in the case of the special-purpose network device 502, one or more such servers could also be run on a virtualization layer executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., an NE/VNE on an ND, a part of an NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs. In one embodiment, the network controller 578 may include an NE data migration component 581 that implements embodiments of the NE data migration processes described herein above.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (an NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of an NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

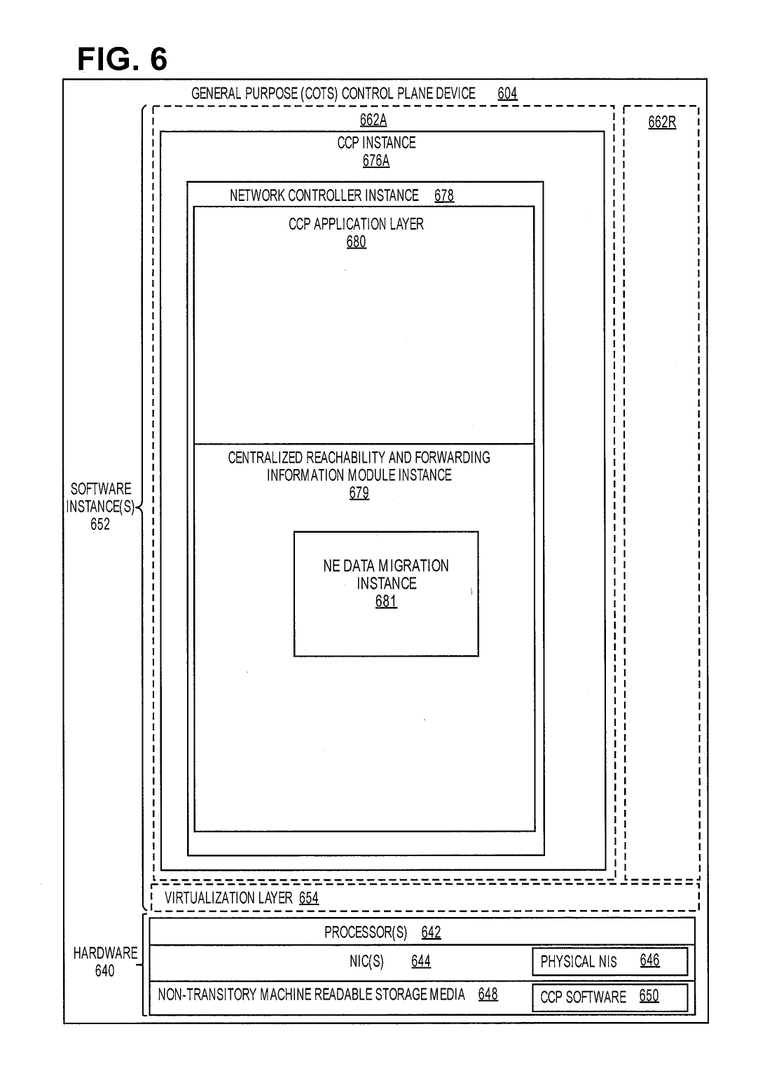

Similar to the network device implementations, the electronic device(s) running the centralized control plane 576, and thus the network controller 578 including the centralized reachability and forwarding information module 579, may be implemented in a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein centralized control plane (CCP) software 650.

In embodiments that use compute virtualization, the processor(s) 642 typically execute software to instantiate a virtualization layer 654 and software container(s) 662A-R (e.g., with operating system-level virtualization, the virtualization layer 654 represents the kernel of an operating system (or a shim executing on a base operating system) that allows for the creation of multiple software containers 662A-R (representing separate user space instances and also called virtualization engines, virtual private servers, or jails) that may each be used to execute a set of one or more applications; with full virtualization, the virtualization layer 654 represents a hypervisor (sometimes referred to as a virtual machine monitor (VMM)) or a hypervisor executing on top of a host operating system, and the software containers 662A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 650 (illustrated as CCP instance 676A) is executed within the software container 662A on the virtualization layer 654. In embodiments where compute virtualization is not used, the CCP instance 676A on top of a host operating system is executed on the “bare metal” general purpose control plane device 604. The instantiation of the CCP instance 676A, as well as the virtualization layer 654 and software containers 662A-R if implemented, are collectively referred to as software instance(s) 652.

In some embodiments, the CCP instance 676A includes a network controller instance 678. The network controller instance 678 includes a centralized reachability and forwarding information module instance 679 (which is a middleware layer providing the context of the network controller 578 to the operating system and communicating with the various NEs), and an CCP application layer 680 (sometimes referred to as an application layer) over the middleware layer (providing the intelligence required for various network operations such as protocols, network situational awareness, and user-interfaces). At a more abstract level, this CCP application layer 680 within the centralized control plane 576 works with virtual network view(s) (logical view(s) of the network) and the middleware layer provides the conversion from the virtual networks to the physical view. In one embodiment, the centralized reachability and forwarding information module instance 679 may include an NE data migration instance 681 for performing embodiments of the NE data migration processes described herein above.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, forward the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occur, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of an NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to an NE/VNE implemented on a ND can be referred to as IP addresses of that NE/VNE.

While the invention has been described in terms of several embodiments, those skilled in the art will recognize that the invention is not limited to the embodiments described, but can be practiced with modification and alteration within the spirit and scope of the appended claims and descriptions provided herein. The description is thus to be regarded as illustrative instead of limiting.

What is claimed is:

1. A method performed by a controller node to support network element (NE) data migration, the controller node is part of a cluster of controller nodes in a software defined networking (SDN) network, the method comprising:
detecting that a peer controller node in a same replication zone as the controller node has failed, wherein the peer controller node is a master for data associated with an NE and the controller node is a backup for the data associated with the NE;
transitioning a state of the NE to a migration state;
transferring the data associated with the NE from backup storage (Zb) of the controller node to dead storage (Zd) of the controller node;
receiving a request for the data associated with the NE from a requesting controller node; and
transferring at least a fragment of the data associated with the NE to the requesting controller node.

2. The method of claim 1, further comprising:
transmitting a done message to the requesting controller node that indicates that transfer of the data associated with the NE has completed.

3. The method of claim 2, further comprising:
receiving an acknowledgment message from the requesting controller node that indicates that the done message has been received; and
deleting the data associated with the NE from the Zd of the controller node upon receiving the acknowledgment message.

4. The method of claim 1, further comprising:
receiving a connection request from a connecting NE;
transitioning a state of the connecting NE to a migration state if the connecting NE is not already in the migration state;
selecting a replication zone;
determining if a Zd of a controller node in the selected replication zone includes data associated with the connecting NE;
upon determining that the Zd of the controller node in the selected replication zone includes data associated with the connecting NE,
requesting the data associated with the connecting NE from the controller node in the selected replication zone,
receiving at least a fragment of the data associated with the connecting NE from the controller node in the selected replication zone, and
storing the received fragment of the data associated with the connecting NE in the Zd of the controller node;
determining whether all replication zones in the cluster of controller nodes have been selected; and
upon determining that all replication zones in the cluster of controller nodes have been selected,
transferring the data associated with the connecting NE from the Zd of the controller node to master storage (Zm) of the controller node, and
transitioning the state of the connecting NE to a stable state.

5. The method of claim 4, further comprising:
upon determining that not all replication zones in the cluster of controller nodes have been selected, selecting another replication zone not previously selected for determining if a Zd of a controller node in the selected another replication zone includes data associated with the connecting NE.

6. The method of claim 4, further comprising:
receiving a done message from the controller node in the selected replication zone that indicates that transfer of the data associated with the connecting NE has completed; and
upon receiving the done message from the controller node in the selected replication zone, transmitting an acknowledgment message to the controller node in the selected replication zone that indicates that the done message has been received.

7. The method of claim 4, further comprising:
causing the data associated with the connecting NE that is stored in the Zd of the controller node to be replicated at one or more peer controller nodes of the controller node.

8. The method of claim 4, further comprising:
modifying the data associated with the connecting NE while the connecting NE is in the migration state.

9. A network device configured to support network element (NE) data migration, the network device implements a controller node in a cluster of controller nodes in a software defined networking (SDN) network, the network device comprising:
a non-transitory machine readable storage medium to store a NE data migration component; and
a processor communicatively coupled to the non-transitory machine readable storage medium, the processor configured to execute the NE data migration component, wherein the NE data migration component is configured to detect that a peer controller node in a same replication zone as the controller node has failed, wherein the peer controller node is a master for data associated with an NE and the controller node is a backup for the data associated with the NE, transition a state of the NE to a migration state, cause the data associated with the NE to be transferred from backup storage (Zb) of the controller node to dead storage (Zd) of the controller node, and in response to a request for the data associated with the NE from a requesting controller node, cause at least a fragment of the data associated with the NE to be transferred to the requesting controller node.

10. The network device of claim 9, wherein the NE data migration component is further configured to, in response to a connection request from a connecting NE, transition a state of the connecting NE to a migration state if the connecting NE is not already in the migration state, select a replication zone, determine if a Zd of a controller node in the selected replication zone includes data associated with the connecting NE, and upon a determination that the Zd of the controller node in the selected replication zone includes data associated with the connecting NE,
cause to be transmitted a request for the data associated with the connecting NE from the controller node in the selected replication zone, store at least a fragment of the data associated with the connecting NE received from the controller node in the selected replication zone in the Zd of the controller node, and cause the received fragment of the data associated with the connecting NE to be replicated to one or more peer controller nodes in a same replication zone as the controller node,
wherein the NE data migration component is further configured to determine whether all replication zones in the cluster of controller nodes have been selected, and upon a determination that all replication zones in the cluster of controller nodes have been selected,
cause the data associated with the connecting NE to be transferred from the Zd of the controller node to master storage (Zm) of the controller node and transition the state of the connecting NE to a stable state.

11. A non-transitory computer readable medium having instructions stored therein to be executed by a network device for supporting network element (NE) data migration, the network device acts as a controller node in a cluster of controller nodes in a software defined networking (SDN) network, the instructions when executed by the network device cause the network device to perform a set of operations comprising:
detecting that a peer controller node in a same replication zone as the controller node has failed, wherein the peer controller node is a master for data associated with an NE and the controller node is a backup for the data associated with the NE;
transitioning a state of the NE to a migration state;
transferring the data associated with the NE from backup storage (Zb) of the controller node to dead storage (Zd) of the controller node;
receiving a request for the data associated with the NE from a requesting controller node; and
transferring at least a fragment of the data associated with the NE to the requesting controller node.

12. The non-transitory computer readable medium of claim 11, wherein the instructions when executed by the network device cause the network device to perform a further set of operations comprising:
transmitting a done message to the requesting controller node that indicates that transfer of the data associated with the NE has completed.

13. The non-transitory computer readable medium of claim 11, wherein the instructions when executed by the network device cause the network device to perform a further set of operations comprising:
receiving an acknowledgment message from the requesting controller node that indicates that the done message has been received; and
deleting the data associated with the NE from the Zd of the controller node upon receiving the acknowledgment message.

14. The non-transitory computer readable medium of claim 11, wherein the instructions when executed by the network device cause the network device to perform a further set of operations comprising:
receiving a connection request from a connecting NE;
transitioning a state of the connecting NE to a migration state if the connecting NE is not already in the migration state;
selecting a replication zone;
determining if a Zd of a controller node in the selected replication zone includes data associated with the connecting NE;
upon determining that the Zd of the controller node in the selected replication zone includes data associated with the connecting NE,
requesting the data associated with the connecting NE from the controller node in the selected replication zone,
receiving at least a fragment of the data associated with the connecting NE from the controller node in the selected replication zone, and
storing the at least the fragment of the data associated with the connecting NE in the Zd of the controller node;
determining whether all replication zones in the cluster of controller nodes have been selected; and
upon determining that all replication zones in the cluster of controller nodes have been selected,
transferring the data associated with the connecting NE from the Zd of the controller node to master storage (Zm) of the controller node, and
transitioning the state of the connecting NE to a stable state.

15. The non-transitory computer readable medium of claim 14, wherein the instructions when executed by the network device cause the network device to perform a further set of operations comprising:
upon determining that not all replication zones in the cluster of controller nodes have been selected, selecting another replication zone not previously selected for determining if a Zd of a controller node in the selected another replication zone includes data associated with the connecting NE.

16. The non-transitory computer readable medium of claim 14, wherein the instructions when executed by the network device cause the network device to perform a further set of operations comprising:
receiving a done message from the controller node in the selected replication zone that indicates that transfer of the data associated with the connecting NE has completed; and
upon receiving the done message from the controller node in the selected replication zone, transmitting an acknowledgment message to the controller node in the selected replication zone that indicates that the done message has been received.

17. The non-transitory computer readable medium of claim 14, wherein the instructions when executed by the network device cause the network device to perform a further set of operations comprising:
causing the data associated with the connecting NE that is stored in the Zd of the controller node to be replicated at one or more peer controller nodes in a same replication zone as the controller node.

18. The non-transitory computer readable medium of claim 14, wherein the instructions when executed by the network device cause the network device to perform a further set of operations comprising:
modifying the data associated with the connecting NE while the connecting NE is in the migration state.

19. A computing device implementing a plurality of virtual machines for implementing network function virtualization (NFV), wherein a virtual machine from the plurality of virtual machines is configured to implement a controller node that supports network element (NE) data migration, the controller node is part of a cluster of controller nodes in a software defined networking (SDN) network, the computing device comprising:
a storage medium to store a NE data migration component; and
a processor communicatively coupled to the storage medium, the processor configured to execute the virtual machine, where the virtual machine is configured to implement the NE data migration component, the NE data migration component configured to detect that a peer controller node in a same replication zone as the controller node has failed, wherein the peer controller node is a master for data associated with an NE and the controller node is a backup for the data associated with the NE, transition a state of the NE to a migration state, cause the data associated with the NE to be transferred from backup storage (Zb) of the controller node to dead storage (Zd) of the controller node, and in response to a request for the data associated with the NE from a requesting controller node, cause at least a fragment of the data associated with the NE to be transferred to the requesting controller node.

20. The computing device of claim 19, wherein the NE data migration component is further configured to, in response to a connection request from a connecting NE, transition a state of the connecting NE to a migration state if the connecting NE is not already in the migration state, select a replication zone, determine if a Zd of a controller node in the selected replication zone includes data associated with the connecting NE, and upon a determination that the Zd of the controller node in the selected replication zone includes data associated with the connecting NE,
cause to be transmitted a request for the data associated with the connecting NE from the controller node in the selected replication zone, store at least a fragment of the data associated with the connecting NE received from the controller node in the selected replication zone in the Zd of the controller node, and cause the received fragment of the data associated with the connecting NE to be replicated to one or more peer controller nodes in a same replication zone as the controller node,
wherein the NE data migration component is further configured to determine whether all replication zones in the cluster of controller nodes have been selected, and upon a determination that all replication zones in the cluster of controller nodes have been selected,
cause the data associated with the connecting NE to be transferred from the Zd of the controller node to master storage (Zm) of the controller node and transition the state of the connecting NE to a stable state.
